(19) United States
(12) Patent Application Publication
(10) Pub. No.: US 2025/0389693 A1
(43) Pub. Date: Dec. 25, 2025

(54) LEAKAGE MAGNETIC FIELD GRAPH TESTING METHOD AND APPARATUS FOR IN-SERVICE CABLE DAMAGE

(71) Applicant: Huazhong University of Science and Technology, Wuhan (CN)

(72) Inventors: Xinjun WU, Wuhan (CN); Lingsi SUN, Wuhan (CN); Zhiwei TAO, Wuhan (CN)

(21) Appl. No.: 18/818,547

(22) Filed: Aug. 28, 2024

(30) Foreign Application Priority Data
Jun. 24, 2024 (CN) 202410818913.8

(51) Int. Cl. G01N 27/87

(52) U.S. Cl. CPC G01N 27/87

(57) ABSTRACT

A leakage magnetic field graph testing method for in-service cable damage includes: acquiring multi-channel detection signals corresponding to respective testing units in a testing probe; slicing the multi-channel detection signals acquired at different detection positions to acquire sliced detection data at a plurality of detection positions in an axial direction of a cable under test; mapping the sliced detection data to a pre-constructed graph structure to acquire sliced graphs, wherein the graph structure is established on the basis of spatial distribution of the testing units in the testing probe, the testing units serving as nodes, and adjacency relationships between the testing units in the testing probe serving as edges; and determining a frequency spectrum of a graph signal in each sliced graph by means of a graph Fourier transform.

### TECHNICAL FIELD

The present application pertains to the technical field of bridge cable testing, and more specifically relates to a leakage magnetic field graph testing method and apparatus for in-service cable damage.

### BACKGROUND ART

Cables are an important load-bearing part of a suspension bridge, and are directly related to the safety of the bridge. During long-term use, the cables are subjected to extremely heavy constant load, live load, alternating stress, vibration, etc., so that broken wires caused by fatigue are prone to occur, thereby severely affects the safety of the bridge. Therefore, it is vital to test the health condition of steel wires inside the cables in a timely manner. Magnetic flux leakage testing methods have been widely used in non-destructive testing for cable damage due to advantages such as its simple principle, high defect detection sensitivity, high online detection capabilities, low costs, and the like.

In the related art, in order to perform a comprehensive test for damage inside a cable, a multi-channel magnetic flux leakage testing probe capable of circumferentially covering the cable needs to be mounted on a cable climbing robot, so that the robot performs axial scans along the cable, thereby acquiring multi-channel detection signals. A technician then uses the multi-channel detection signals to perform cable damage detection. However, due to the large length of the cable, the large number of testing channels, and the large amount of acquired data, manual evaluation has low efficiency and increases the risk of false determination. In addition, detection signals are susceptible to lift-off fluctuations during testing, resulting in background interference signals occurring in testing channels, thereby increasing the difficulty of manual interpretation, reducing testing accuracy, and causing many inconveniences for cable health status evaluation.

### SUMMARY OF THE INVENTION

Embodiments of the present application provide a leakage magnetic field graph testing method and apparatus for in-service cable damage.

In a first aspect, an embodiment of the present application provides a leakage magnetic field graph testing method for in-service cable damage, comprising:
acquiring multi-channel detection signals corresponding to respective testing units in a testing probe;
slicing the multi-channel detection signals acquired at different detection positions to acquire sliced detection data at a plurality of detection positions in an axial direction of a cable under test;
mapping the sliced detection data to a pre-constructed graph structure to acquire sliced graphs, wherein the graph structure is established on the basis of spatial distribution of the testing units in the testing probe, the testing units serving as nodes, and adjacency relationships between the testing units in the testing probe serving as edges;
determining a frequency spectrum of a graph signal in each sliced graph by means of a graph Fourier transform;
determining a low-frequency signal energy characteristics value of each sliced graph on the basis of the frequency spectrum of the graph signal in each sliced graph; and
determining, on the basis of the low-frequency signal energy characteristics value of each sliced graph, whether damage is present at a detection position corresponding to the sliced graph.

In a second aspect, an embodiment of the present application further provides a leakage magnetic field graph testing apparatus for in-service cable damage, comprising:
a first acquisition module, configured to acquire multi-channel detection signals corresponding to respective testing units in a testing probe;
a second acquisition module, configured to slice the multi-channel detection signals acquired at different detection positions to acquire sliced detection data at a plurality of detection positions in an axial direction of a cable under test;
a third acquisition module, configured to map the sliced detection data to a pre-constructed graph structure to acquire sliced graphs, wherein the graph structure is established on the basis of spatial distribution of the testing units in the testing probe, the testing units serving as nodes, and adjacency relationships between the testing units in the testing probe serving as edges;
a transform module, configured to determine a frequency spectrum of a graph signal in each sliced graph by means of a graph Fourier transform;
a first determination module, configured to determine a low-frequency signal energy characteristics value of each sliced graph on the basis of the frequency spectrum of the graph signal in each sliced graph; and
a second determination module, configured to determine, on the basis of the low-frequency signal energy characteristics value of each sliced graph, whether damage is present at a detection position corresponding to the sliced graph.

In a third aspect, an embodiment of the present application further provides an industrial personal computer, comprising: at least one memory, configured to store a program; and at least one processor, configured to execute the program stored by the memory, wherein when the program stored by the memory is executed, the processor is configured to perform the method according to the first aspect or any possible implementation manner of the first aspect.

In a fourth aspect, an embodiment of the present application further provides a computer-readable storage medium, having a computer program stored therein, wherein when the computer program is run on a processor, the processor is caused to perform the method according to the first aspect or any possible implementation manner of the first aspect.

In a fifth aspect, an embodiment of the present application further provides a computer program product, wherein when the computer program product is run on a processor, the processor is caused to perform the method according to the first aspect or any possible implementation manner of the first aspect.

In the leakage magnetic field graph testing method and apparatus for in-service cable damage provided in the embodiments of the present application, a plurality of testing channels in a testing probe are abstracted as a graph structure, testing units are abstracted as nodes of the graph structure, and adjacency relationships between the testing units are abstracted as edges of the graph structure. Slicing is performed to acquire sliced detection data of different detection positions, and the sliced detection data is mapped to the nodes in the graph structure to acquire sliced graphs. A frequency spectrum of a graph signal in each sliced graph is acquired by means of graph signal processing technology, so that the damage condition of a cable is determined according to low-frequency signal energy characteristics values, thereby significantly improving the accuracy and efficiency of cable damage detection, and achieving automated magnetic flux leakage testing for bridge cables.

### BRIEF DESCRIPTION OF THE DRAWINGS

In order to describe the technical solutions in the present application or in the related art more clearly, accompanying drawings required for the embodiments or the related technical description will be briefly introduced below. Obviously, the accompanying drawings in the following description are merely some of the embodiments of the present application. Those of ordinary skill in the art can further obtain other accompanying drawings according to these accompanying drawings without the exercise of inventive effort.

FIG. 1 is a schematic flowchart of a leakage magnetic field graph testing method for in-service cable damage according to an embodiment of the present application;

FIG. 2 is a schematic diagram of the arrangement of testing units in a testing probe according to an embodiment of the present application;

FIG. 3 is a related schematic diagram of a graph structure constructed on the basis of the spatial distribution of testing units in a testing probe according to an embodiment of the present application;

FIG. 4 is a schematic distribution diagram of broken wire positions of a Φ109 mm (PES7-127) cable including internal broken wires according to an embodiment of the present application;

FIG. 5 is a schematic signal diagram of multi-channel differential detection signals obtained after denoising and drift removal processing according to an embodiment of the present application;

FIG. 6 is a schematic spectrum diagram of sliced graphs corresponding to broken wire positions according to an embodiment of the present application;

FIG. 7 is a schematic spectrum diagram of a sliced graph corresponding to a position without any broken wire according to an embodiment of the present application;

FIG. 8 is a schematic structural diagram of a leakage magnetic field graph testing apparatus for in-service cable damage according to an embodiment of the present application; and

FIG. 9 is a schematic structural diagram of an industrial personal computer according to an embodiment of the present application.

### DETAILED DESCRIPTION

In order to clarify the objective, technical solutions, and advantages of the present application, the present application is described in further detail below with reference to the accompanying drawings and embodiments. It should be understood that the specific embodiments described herein are only used to explain the present application, and not to limit the present application.

During magnetic flux leakage testing performed by using a multi-channel magnetic flux leakage testing probe that circumferentially covers a cable, on the one hand, due to the large length of the cable, the large number of testing channels, and the large amount of acquired data, manual evaluation has low efficiency and increases the risk of false determination. On the other hand, detection signals are susceptible to lift-off fluctuations during testing, resulting in background interference signals occurring in testing channels, thereby lowering testing accuracy while increasing the difficulty of manual interpretation.

In view of the above problems in the related art, embodiments of the present application provide a leakage magnetic field graph testing method and apparatus for in-service cable damage. A plurality of testing channels in a testing probe are abstracted as a graph structure, testing units are abstracted as nodes of the graph structure, and adjacency relationships between the testing units are abstracted as edges of the graph structure. Slicing is performed to acquire sliced detection data of different detection positions, and the sliced detection data is mapped to the nodes in the graph structure to acquire sliced graphs. A frequency spectrum of a graph signal in each sliced graph is acquired by means of graph signal processing technology, so that the damage condition of a cable is determined according to low-frequency signal energy characteristics values, thereby significantly improving the accuracy and efficiency of cable damage detection, and achieving automated magnetic flux leakage testing for bridge cables.

FIG. 1 is a schematic flowchart of a leakage magnetic field graph testing method for in-service cable damage according to an embodiment of the present application. As shown in FIG. 1, the method may be performed by an industrial personal computer or another electronic device, and the method at least includes the following steps:

S101, acquiring multi-channel detection signals corresponding to respective testing units in a testing probe.

Specifically, a scan is performed in an axial direction of a cable under test by using a multi-channel magnetic flux leakage testing probe that circumferentially covers the cable, to acquire multi-channel detection signals corresponding to respective testing units in the testing probe. Optionally, the testing probe includes a plurality of testing units, and the plurality of testing units are uniformly distributed at equal angular intervals in a circumferential direction of the cable under test, so as to circumferentially cover the cable under test.

S102, slicing the multi-channel detection signals acquired at different detection positions to acquire sliced detection data at a plurality of detection positions in an axial direction of a cable under test.

Specifically, during the scan performed by the multi-channel magnetic flux leakage testing probe in the axial direction of the cable under test, multi-channel detection signals corresponding to the plurality of testing units in the testing probe may be continuously acquired, and the multi-channel testing signal acquired at different detection positions may be sliced to acquire sliced detection data at a plurality of detection positions in the axial direction of the cable under test. Finally, the multi-channel detection signals for the entire cable are cut into NS segments, where x=[x₁, x₂, . . . , x_{NS}].

S103, mapping the sliced detection data to a pre-constructed graph structure to acquire sliced graphs, wherein the graph structure is established on the basis of spatial distribution of the testing units in the testing probe, the testing units serving as nodes, and adjacency relationships between the testing units in the testing probe serving as edges.

Specifically, the sliced detection data is mapped to a pre-constructed graph structure G=(V,E) to acquire sliced graphs corresponding to the plurality of detection positions.

The graph structure is constructed on the basis of the spatial distribution of the testing units in the testing probe, the testing units serving as nodes, and adjacency relationships between the testing units in the testing probe serving as edges. The graph structure G=(V,E) includes a node set V={v₁, v₂, . . . , v_{M}} and an edge set E={e₁, e₂, . . . , e_{M}}, where M represents the number of the testing units in the testing probe. When a broken wire occurs, a broken wire leakage magnetic field spreads in the surrounding space, and several testing channels close to the broken wire could receive broken wire leakage magnetic field signals at the same time. Signals of adjacent channels have similar waveforms, and the amplitude gradually attenuates as the straight-line distance to the broken wire increases, so that there is a certain relationship between the signals of the adjacent channels, and therefore it is considered to implement in-service cable magnetic flux leakage testing by means of a graph structure.

The respective testing units in the testing probe are uniformly distributed at equal angular intervals in the circumferential direction of the cable under test. The testing units in the testing probe are abstracted as nodes in the graph structure, and adjacent nodes have an adjacency relationship therebetween, thereby acquiring a ring graph structure. In different slices, the sliced detection data is mapped to the graph structure, thereby acquiring sliced graphs corresponding to different detection positions.

S104, determining a frequency spectrum of a graph signal in each sliced graph by means of a graph Fourier transform.

Specifically, a graph signal in the graph structure refers to a set of values associated with the graph nodes. Assuming that n nodes (n is the number of the testing units in the testing probe) are present in the graph structure, then the graph signal may be represented by an n-dimensional vector, and elements in the vector are the mapped sliced detection data corresponding to the respective testing units.

The graph signal in the sliced graph is transformed from the node domain to the frequency domain by means of the graph Fourier transform (GFT) to acquire the frequency spectrum of the graph signal, that is, frequency distribution. Signal characteristics in the sliced graph can be better understood by means of the graph Fourier transform, and the processing is performed in the frequency domain.
S105, determining a low-frequency signal energy characteristics value of each sliced graph on the basis of the frequency spectrum of the graph signal in each sliced graph.
S106, determining, on the basis of the low-frequency signal energy characteristics value of each sliced graph, whether damage is present at a detection position corresponding to the sliced graph.

Specifically, by analyzing the frequency spectrum of the graph signal in each sliced graph, it is ascertained that a single peak is prone to occur in the original signal waveform of a channel near a broken wire position, so that broken wire signals are concentrated in a low frequency band in the graph frequency spectrum. That is, the frequency of the graph signal in a sliced graph including damage is mainly concentrated in a low frequency range, and the amplitude of the low frequency is relatively large, so that the low-frequency signal energy characteristics value is relatively large. The frequency distribution of the graph signal in a sliced graph without any damage is more uniform, and the low-frequency signal energy characteristics value is relatively small.

Signal energy characteristics values of low-frequency signals in a sliced graph are superimposed to acquire a low-frequency signal energy characteristics value (LGE) of the sliced graph, so as to determine, according to the low-frequency signal energy characteristics value of each sliced graph, whether damage is present at the detection position corresponding to the sliced graph.

In the leakage magnetic field graph testing method for in-service cable damage provided in the embodiments of the present application, a plurality of testing channels in a testing probe are abstracted as a graph structure, testing units are abstracted as nodes of the graph structure, and adjacency relationships between the testing units are abstracted as edges of the graph structure. Slicing is performed to acquire sliced detection data of different detection positions, and the sliced detection data is mapped to the nodes in the graph structure to acquire sliced graphs. A frequency spectrum of a graph signal in each sliced graph is acquired by means of graph signal processing technology, so that the damage condition of a cable is determined according to low-frequency signal energy characteristics values, thereby significantly improving the accuracy and efficiency of cable damage detection, and achieving automated magnetic flux leakage testing for bridge cables.

In some embodiments, S104 specifically includes:
performing eigen decomposition on a Laplacian matrix of the sliced graph, determining an eigenvalue matrix and a corresponding eigenvector matrix, using an eigenvalue as a frequency of the graph signal, and using an eigenvector as a graph Fourier transform basis;
determining a graph Fourier transform coefficient at each frequency component on the basis of node data in the sliced graph; and
determining the frequency spectrum of the graph signal in the sliced graph on the basis of the graph Fourier transform coefficient.

Specifically, in order for a graph signal in a slice to be transformed from the node domain to the frequency domain by means of a graph Fourier transform, it is necessary to find eigenvectors (i.e., the graph Fourier transform basis) of the Laplacian matrix, and the result of the graph Fourier transform is projection coefficients (graph Fourier transform coefficients) of the signal on these eigenvectors, i.e., the frequency domain representation of the signal.

Eigen decomposition is performed on a Laplacian matrix L of the sliced graph, to acquire an eigenvalue matrix Λ and a corresponding eigenvector matrix V:

$$L = V Λ {V}^{T} = [ \begin{matrix}⋮ & ⋮ & … & ⋮ \\ {v}_{1} & {v}_{2} & … & {v}_{N} \\ ⋮ & ⋮ & … & ⋮\end{matrix} ] [ \begin{matrix}{λ}_{1} & & & \\ & {λ}_{2} & & \\ & & ⋱ & \\ & & & {λ}_{N}\end{matrix} ] [ \begin{matrix}… & {v}_{1} & … \\ … & {v}_{2} & … \\ … & ⋮ & … \\ … & {v}_{N} & …\end{matrix} ]$$

An eigenvalue is equivalent to a frequency eigenvalue of a graph signal, and a corresponding eigenvector is a graph Fourier transform basis, and may be regarded as a frequency component on the graph. Corresponding graph signal frequencies and corresponding graph Fourier transform bases are acquired by arranging the eigenvalues in ascending order, where a small eigenvalue corresponds to low-frequency separation, and the corresponding eigenvector v is also a low-frequency graph Fourier transform basis. The graph Fourier transform coefficient at each frequency component is as follows:

$${\tilde{X}}_{m} = {V}_{m}^{T} x = {v}_{m} , x$$

where X̅ₘ is a coefficient of the graph Fourier transform with respect to the eigenvalue λₘ, i.e., the graph Fourier transform coefficient. The graph Fourier transform coefficient is equivalent to the amplitude of the graph signal at the corresponding frequency component, reflecting the strength of the graph signal at the frequency component. Thus, the acquired frequency distribution of the graph signal in the sliced graph is as follows:

$$\tilde{X} = {V}^{T} x , x ∈ {R}^{N}$$

Further, the Laplacian matrix is a matrix representing a graph structure, and includes encoded connection information between nodes of a graph. For an undirected graph, the Laplacian matrix is typically defined as a degree matrix minus an adjacency matrix. For each sliced graph G=(V,E), the nodes correspond to the testing units in the testing probe, and two adjacent nodes have an adjacency relationship therebetween. The elements in the adjacency matrix A represent the number of edges between the nodes, and in an undirected graph, the number of edges between the nodes is 0 or 1, so that the elements in the adjacency matrix A may be expressed as:

$${A}_{i j} = \{ \begin{matrix}1 & if ( {v}_{i} , {v}_{j} ) ∈ E \\ 0 & if ( {v}_{i} , {v}_{j} ) ∉ E\end{matrix}$$

After the adjacency matrix A is acquired, the degree matrix D can be acquired. The degree matrix D is a diagonal matrix in which elements can be expressed as:

$${D}_{ii} = {\sum }_{j} {A}_{ij}$$

After the adjacency matrix A and the degree matrix D are acquired, the Laplacian matrix L can be expressed as follows:

$$L = D - A$$

In the leakage magnetic field graph testing method for in-service cable damage provided in the embodiments of the present application, a graph signal in a sliced graph is processed by means of a graph Fourier transform to be transformed from the node domain to the frequency domain, so that cable damage detection can be performed subsequently by using frequency distribution of graph signals in sliced graphs at different detection positions.

In some embodiments, S105 specifically includes:
determining an energy characteristics value of the graph signal on the basis of the frequency spectrum of the graph signal in the sliced graph; and
accumulating low-frequency signal energies in the graph signal that have frequencies less than a low-frequency cut-off frequency, and determining the low-frequency signal energy characteristics value of the sliced graph.

Specifically, by comparing frequency spectra of sliced graphs with and without defects, it is determined that the frequency of the graph signal in a sliced graph having a broken wire defect is mostly concentrated in a low frequency range, and the amplitude of the low frequency is relatively large. The frequency distribution of the graph signal in the sliced graph without any broken wire is relatively uniform. Hence, a low-frequency signal energy value LGE of the sliced graph is proposed, and cable damage detection is implemented by means of the LGE.

The frequency distribution of the graph signal in the sliced graph is as follows:

$$\tilde{X} = {V}^{T} x , x ∈ {R}^{N}$$

Accordingly, signal energy of each frequency component is acquired as follows:

$$G E ( x ) = ‖ x ‖ = {x}^{T} x = {( V \tilde{X} )}^{T} ( V \tilde{X} ) = {\tilde{X}}^{T} X$$

Low-frequency signal energies in the graph signal that have frequencies less than the low-frequency cut-off frequency are accumulated to acquire the low-frequency signal energy characteristics value LGE of the sliced graph. The low-frequency cut-off frequency is set according to the actual situation.

In the leakage magnetic field graph testing method for in-service cable damage provided in the embodiments of the present application, low-frequency signal energies in a sliced graph that have graph signal frequencies less than a low-frequency cut-off frequency are accumulated to acquire LGE of the sliced graph, and the LGE is used to determine whether damage is present at a detection position corresponding to the sliced graph, thereby achieving automated magnetic flux leakage testing for bridge cables. In addition, compared with directly comparing detection signals output at different detection positions by respective testing units, the method has better testing performance for deeper-layer broken wires.

In some embodiments, S106 specifically includes:
comparing the low-frequency signal energy characteristics value of each sliced graph with a standard characteristics value, and determining that damage is present at a detection position corresponding to a sliced graph of which the low-frequency signal energy characteristics value is greater than the standard characteristics value.

Specifically, the low-frequency signal energy characteristics value of each sliced graph is compared with the standard characteristics value. If the low-frequency signal energy characteristics value of the sliced graph is greater than the standard characteristics value, it is considered that damage is present at the detection position corresponding to the sliced graph; otherwise, it is considered that there is no damage at the corresponding detection position. The standard characteristics value is associated with the low-frequency signal energy characteristics value of a sliced graph without any damage.

In some embodiments, the standard characteristics value is determined in the following manners:
determining the standard characteristics value on the basis of a predetermined low-frequency signal energy characteristics value of a sliced graph without any damage; or,
determining the standard characteristics value on the basis of a minimum value among the low-frequency signal energy characteristics values of the respective sliced graphs.

Specifically, the standard characteristics value may be set by using the following methods:
Method 1: the standard characteristics value is determined on the basis of a predetermined low-frequency signal energy characteristics value of a sliced graph without any damage. Optionally, an average value of low-frequency signal energy characteristics values of sliced graphs of a plurality of detection positions for a cable without any damage is acquired, and is used as the standard characteristics value. Furthermore, even for a cable without any damage, low-frequency signal energy characteristics values of sliced graphs of a plurality of detection positions are different from each other, and it is necessary to consider the low-frequency signal energy characteristics values. Optionally, the maximum value among low-frequency signal energy characteristics values of sliced graphs of a plurality of detection positions for a cable without any damage is used as the standard characteristics value. Optionally, an average value of low-frequency signal energy characteristics values of sliced graphs of a plurality of detection positions for a cable without any damage is acquired, and a fluctuation threshold is also set. The sum of the average value and the fluctuation threshold is used as the standard characteristics value.
Method 2: determining the standard characteristics value on the basis of a minimum value among the low-frequency signal energy characteristics values of the respective sliced graphs.

During the actual operation, a cable under test has portions without any broken wire, and among all low-frequency signal energy characteristics values acquired by scanning the cable, detection positions on the cable corresponding to sliced graphs having a significantly small low-frequency signal energy characteristics value are considered to be without damage. Therefore, the standard characteristics value is determined on the basis of the minimum value among low-frequency signal energy characteristics values of all slices of the cable under test. Optionally, the sum of the minimum value and a preset fluctuation threshold is used as the standard characteristics value.

As can be seen, in Method 1, it is necessary to acquire in advance standard characteristics values for cables of different specifications before testing. In Method 2, the standard characteristics value can be adaptively determined during each test.

In the leakage magnetic field graph testing method for in-service cable damage provided in the embodiments of the present application, a low-frequency signal energy characteristics value of each sliced graph is compared with a standard characteristics value, so as to determine whether damage is present at a detection position corresponding to the sliced graph, thereby further clarifying an automated process of in-service cable magnetic flux leakage testing.

In some embodiments, S101 specifically includes:
preprocessing detection signals output by magneto sensitive elements in the respective testing units to acquire the multi-channel detection signals corresponding to the respective testing units.

Specifically, the main body of a cable under test includes parallel wire tendons and a sheath for protecting the wire tendons. The sheath is usually made from a non-ferromagnetic material. A lift-off effect is generated when a non-ferromagnetic covering layer is present between the testing probe and the cable. A lift-off distance refers to a distance between the testing probe and a cable surface. When the lift-off distance is small, the testing signal is significantly affected by the lift-off distance, and the signal changes dramatically. A slight lift-off variation may also cause large fluctuation in the testing signal, resulting in a background interference signal in the testing channel, thereby reducing the accuracy of cable damage detection.

On that basis, it is necessary to preprocess the original testing signal output by magneto sensitive elements in the testing units to reduce or eliminate the fluctuation of the testing signal caused by the lift-off variation, and to ensure that the fluctuation of the testing signal is caused by cable damage rather than the lift-off variation.

Each testing unit in the testing probe includes K magneto sensitive elements, and K is a positive integer.

Optionally, the value of K is 1, and in this case, the testing probe includes a plurality of testing units uniformly covering the cable in the circumferential direction of the cable. Each testing unit includes one magneto sensitive element, and the plurality of magneto sensitive elements uniformly cover the cable in the circumferential direction of the cable.

Optionally, the value of K is greater than 1, and in this case, the testing probe includes a plurality of testing units uniformly covering the cable in the circumferential direction of the cable. Each testing unit includes a plurality of magneto sensitive elements, and the plurality of magneto sensitive elements in each testing unit are arranged along a radial gradient of the cable. Optionally, the plurality of magneto sensitive elements in each testing unit are arranged along a radially equidistant gradient of the cable.

In some embodiments, the preprocessing detection signals output by magneto sensitive elements in the respective testing units specifically includes:
if the value of K is 1, performing denoising processing and drift removal processing on a testing signal of the one magneto sensitive element in the testing unit; or,
if the value of K is greater than 1, performing differential processing on detection signals of the K magneto sensitive elements in the testing unit; or,
if the value of K is greater than 1, performing differential processing on detection signals of the K magneto sensitive elements in the testing unit, and further performing denoising processing and drift removal processing on differential detection signals.

Specifically, the denoising processing can remove unnecessary noise in the signal, and the noise reduction can significantly improve the quality of the signal, thereby reflecting the actual situation more accurately. The denoising processing can reduce the instability or distortion of the testing signal caused by the lift-off effect, thereby improving the final testing accuracy.

The drift removal processing can stabilize a signal baseline, improve a signal-to-noise ratio, improve signal quality, and the like. The drift removal processing indirectly reduces the impact of the lift-off effect by improving signal stability and accuracy.

The differential processing can highlight a varying portion in the signal and suppress a relatively stable portion. During the scan performed on the cable by means of the testing probe, the impact of the lift-off effect on the testing signal can be effectively reduced by optimizing the design of the testing probe, adjusting the lift-off distance, and the like. At the time, the interference signal caused by the lift-off fluctuation etc., is relatively stable or changes slowly, while the signal fluctuation caused by the cable damage is relatively obvious. The differential processing can effectively reduce the impact of the interference signal on the testing result, and can also more clearly show variations in the signal. These variations are mostly related to cable defects, and the differential processing can facilitate identification of these features.

If the value of K is 1, that is, if the testing unit includes one magneto sensitive element, denoising processing and drift removal processing are performed on a testing signal of the one magneto sensitive element in the testing unit; or, if the value of K is greater than 1, that is, if the testing unit includes a plurality of magneto sensitive elements, differential processing is performed on detection signals of the K magneto sensitive elements in the testing unit; or, if the value of K is greater than 1, that is, if the testing unit includes a plurality of magneto sensitive elements, differential processing is performed on detection signals of the K magneto sensitive elements in the testing unit, and denoising processing and drift removal processing are further performed on differential detection signals.

Further, if the value of K is greater than 1, that is, if one testing unit includes a plurality of magneto sensitive elements, differential processing may be performed in different manners. For example, if the value of K is 2, that is, if one testing unit includes two magneto sensitive elements, optionally, differential processing is performed on detection signals of the two magneto sensitive elements to acquire one differential testing signal. For example, if the value of K is greater than 2, that is, if one testing unit includes more than two magneto sensitive elements, differential processing may be performed in a more complex manner. Optionally, detection signals of two selected specific magneto sensitive elements undergo differential processing, so as to acquire one differential testing signal. Optionally, detection signals of a plurality of magneto sensitive elements undergo differential processing in pairs, so as to acquire a plurality of differential detection signals.

In the leakage magnetic field graph testing method for in-service cable damage provided in the embodiments of the present application, the impact of an interference signal on the testing result is reduced by means of denoising processing, drift removal processing, differential processing, and the like, thereby further improving testing accuracy. In addition, different preprocessing methods are used for different types of testing probes, thereby meeting actual application requirements better.

In some embodiments, the graph structure-based magnetic flux leakage testing method for an in-service cable further includes:
configuring the testing units in the testing probe to be uniformly distributed in the circumferential direction of the cable under test, and establishing a ring graph structure G=(V,E) on the basis of the spatial distribution of the testing units in the testing probe, where V={v₁, v₂, . . . , v_{M}} represents a node set of the graph structure, E={e₁, e₂, . . . , e_{M}} represents an edge set of the graph structure, and M represents the number of the testing units in the testing probe; and
determining an adjacency matrix and a degree matrix of the graph structure, and determining a Laplacian matrix on the basis of the adjacency matrix and the degree matrix.

Specifically, before the magnetic flux leakage testing for an in-service cable is performed, the graph structure corresponding to the testing units in the testing probe may be established in advance, and related matrices may be calculated.

The testing units in the testing probe are uniformly distributed in the circumferential direction of the cable under test, and a ring graph structure G=(V,E) is established on the basis of the spatial distribution of the testing units in the testing probe, where V={v₁, v₂, . . . , v_{M}} represents a node set of the graph structure, E={e₁, e₂, . . . , e_{M}} represents an edge set of the graph structure, and M represents the number of the testing units in the testing probe. Further, an adjacency matrix and a degree matrix of the graph structure are calculated and determined, and a Laplacian matrix is calculated on the basis of the adjacency matrix and the degree matrix.

The technical solution provided in the embodiments of the present application is further described below using a specific example.

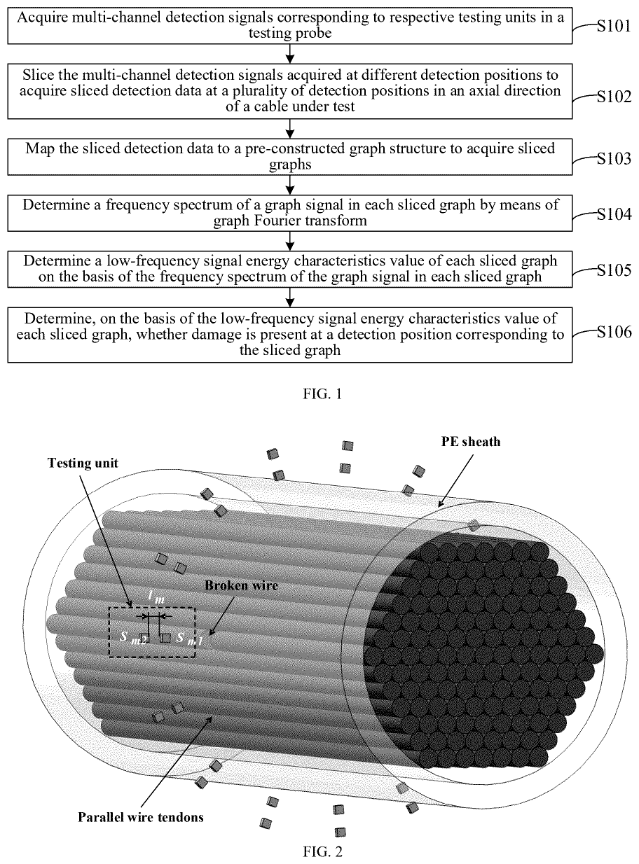

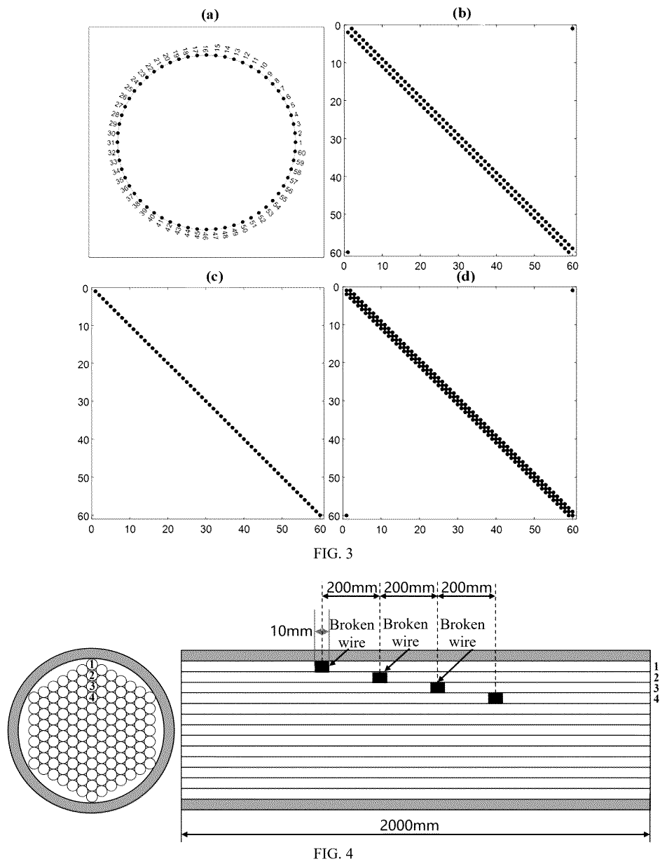

FIG. 2 is a schematic diagram of the arrangement of testing units in a testing probe according to an embodiment of the present application. As shown in FIG. 2, the main body of a cable under test includes parallel wire tendons and a PE sheath. A plurality of testing units in a testing probe (not shown in FIG. 2) are uniformly distributed in a circumferential direction of the cable. Each testing unit includes two magneto sensitive elements Sₘ₁ and Sₘ₂, and a distance between the two magneto sensitive elements is Iₘ. The specification of the cable under test is Φ 109 mm (PES7-127). An effective testing range of each testing unit is about 8 mm in the circumferential direction. It is determined, according to the specification of the cable and the effective testing range of each testing unit, that 60 testing units (M=60) need to be uniformly arranged in the circumferential direction of the cable in order to circumferentially and completely cover the Φ 109 mm (PES7-127) cable. The distance Iₘ between the two magneto sensitive elements in the testing unit is set to 4 mm.

Performing graph structure-based magnetic flux leakage testing for the cable shown in FIG. 2 specifically includes the following steps:

S1, constructing a ring graph structure G=(V,E) on the basis of spatial distribution of testing units in a testing probe, and calculating a Laplacian matrix of the ring graph structure. 60 testing units are abstracted as 60 nodes in the ring graph structure. Adjacency relationships between the testing units are abstracted as edges between the nodes. The ring graph structure includes 60 nodes and 60 edges totally. Accordingly, an adjacency matrix A, a degree matrix D, and a Laplacian matrix L of the ring graph structure can be calculated, and the three matrices are specifically as follows:

$$A = [ \begin{matrix}0 & 1 & 0 & … & 0 & 0 & 1 \\ 1 & 0 & 1 & 0 & … & 0 & 0 \\ 0 & 1 & 0 & ⋱ & ⋱ & ⋮ & 0 \\ ⋮ & 0 & ⋱ & ⋱ & ⋱ & 0 & ⋮ \\ 0 & ⋮ & ⋱ & ⋱ & 0 & 1 & 0 \\ 0 & 0 & … & 0 & 1 & 0 & 1 \\ 1 & 0 & 0 & … & 0 & 1 & 0\end{matrix} ]$$

$$D = [ \begin{matrix}1 & 0 & 0 & … & 0 & 0 & 0 \\ 0 & 1 & 0 & … & 0 & 0 & 0 \\ 0 & 0 & 1 & ⋱ & 0 & 0 & 0 \\ ⋮ & ⋮ & ⋱ & ⋱ & ⋱ & ⋮ & ⋮ \\ 0 & 0 & 0 & ⋱ & 1 & 0 & 0 \\ 0 & 0 & 0 & … & 0 & 1 & 0 \\ 0 & 0 & 0 & … & 0 & 0 & 1\end{matrix} ]$$

$$L = [ \begin{matrix}2 & - 1 & 0 & … & 0 & 0 & - 1 \\ - 1 & 2 & - 1 & 0 & … & 0 & 0 \\ 0 & - 1 & 2 & ⋱ & ⋱ & ⋮ & 0 \\ ⋮ & 0 & ⋱ & ⋱ & ⋱ & 0 & ⋮ \\ 0 & ⋮ & ⋱ & ⋱ & 2 & - 1 & 0 \\ 0 & 0 & … & 0 & - 1 & 2 & - 1 \\ - 1 & 0 & 0 & … & 0 & - 1 & 2\end{matrix} ]$$

FIG. 3 is a related schematic diagram of a graph structure constructed on the basis of the spatial distribution of testing units in a testing probe according to an embodiment of the present application. FIG. 3(a) is a schematic structural diagram of the ring graph structure G=(V,E). FIG. 3(b) is a schematic diagram of non-zero elements of the adjacency matrix of the ring graph structure G=(V,E). FIG. 3(c) is a schematic diagram of non-zero elements of the degree matrix of the ring graph structure G=(V,E). FIG. 3(d) is a schematic diagram of non-zero elements of the Laplacian matrix of the ring graph structure G=(V,E).

S2, acquiring detection signals and performing preprocessing. Differential processing is performed on output signals of two magneto sensitive elements Sₘ₁ and Sₘ₂ in each testing unit, so as to acquire differential detection signals sd₁ to sd₆₀ of 60 channels. Further, denoising processing and drift removal processing are respectively performed on the differential detection signals. The denoising processing uses a moving average method. The drift removal processing uses a least square method to perform fitting to eliminate a trend term, and the order is set to 2.

FIG. 4 is a schematic distribution diagram of broken wire positions of a Φ 109 mm (PES7-127) cable including internal broken wires according to an embodiment of the present application. The left part of FIG. 4 is a schematic cross-sectional view of broken wires in a circumferential direction of the cable. The right part of FIG. 4 is a schematic cross-sectional view of broken wires in an axial direction of the cable. The Φ 109 mm (PES7-127) cable has an overall cable length of 2000 mm, and four broken wires with a break width of 10 mm are preset therein, and are respectively located in layers 1 to 4 of the cable. A distance between the broken wires in the axial direction of the cable is 200 mm.

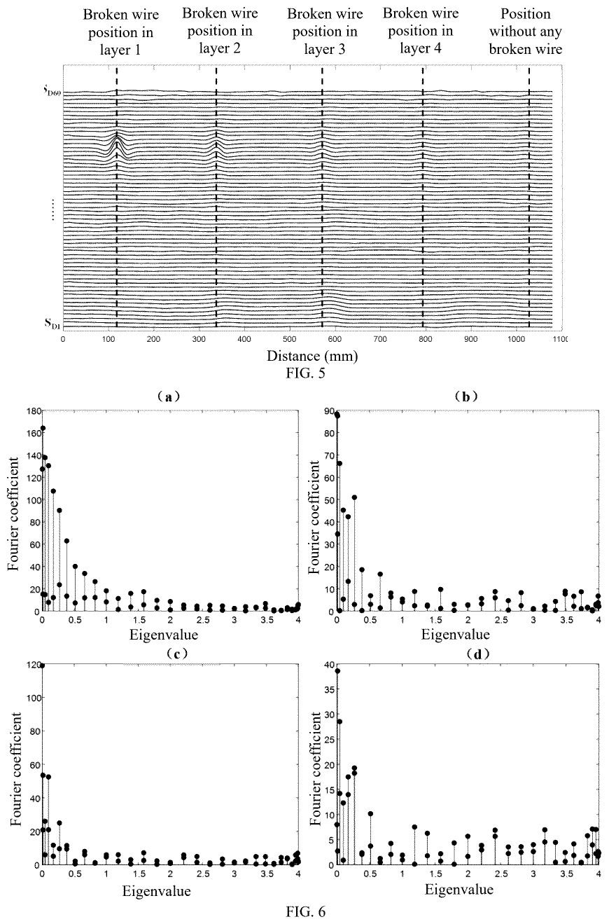

FIG. 5 is a schematic signal diagram of multi-channel differential detection signals obtained after denoising and drift removal processing according to an embodiment of the present application. As shown in FIG. 5, a testing probe performs a scan in an axial direction of a cable to acquire a testing signal for the cable. The operation length of the testing probe is about 990 mm. Signal fluctuation can be seen at all four broken wire positions, where the fluctuation caused by the broken wire at layer 4 is very slight, and a false negative is prone to occur during manual interpretation.
S3, slicing processed differential detection signals to acquire sliced detection data of a plurality of detection positions for the cable. In an actual application, multi-channel differential detection signals at the plurality of detection positions for the cable are acquired at equal intervals and are used as a sliced signal set to acquire sliced detection data of the plurality of detection positions for the cable. The smaller the interval, the higher the slice density, and the more accurate the evaluation of the overall health status of the cable. Here, in order to more intuitively show the effect of the graph structure-based cable magnetic flux leakage testing, differential detection signals of the testing probe at 120 mm, 340 mm, 570 mm, and 795 mm are respectively acquired and used as a sliced signal set, the signals respectively corresponding to differential testing signal peak positions of the four broken wires. For comparison, one detection position without any broken wire is randomly selected, and sliced detection data of said position is acquired. The sliced detection data of the five detection positions are respectively denoted as x₁, x₂, x₃, x₄, and x₅.
S4, mapping the sliced detection data corresponding to the five detection positions in S3 to the ring graph structure G=(V,E) constructed in S1, to acquire five sliced graphs.
S5, calculating a frequency spectrum of a graph signal in each sliced graph. By performing eigen decomposition on the Laplacian matrix of the graph structure, a corresponding eigenvalue matrix and a corresponding eigenvector matrix can be acquired. The number M of testing units=60. Correspondingly, 60 eigenvalues λ and 60 eigenvectors v are acquired. The eigenvalues λ₁˜λ₆ο correspond to frequencies of graph signals, and λ₁≤λ₂≤ . . . ≤λ₆₀. The eigenvectors v₁˜v₆₀ are Fourier bases for the corresponding eigenvalues. The eigen decomposition process of the Laplacian matrix is as follows:

$$L = V Λ {V}^{T} = [ \begin{matrix}⋮ & ⋮ & … & ⋮ \\ {v}_{1} & {v}_{2} & … & {v}_{60} \\ ⋮ & ⋮ & … & ⋮\end{matrix} ] [ \begin{matrix}{λ}_{1} & & & \\ & {λ}_{2} & & \\ & & ⋱ & \\ & & & {λ}_{60}\end{matrix} ] [ \begin{matrix}… & {v}_{1} & … \\ … & {v}_{2} & … \\ … & ⋮ & … \\ … & {v}_{60} & …\end{matrix} ]$$

A graph Fourier transform coefficient corresponding to each frequency component satisfies:

$${\tilde{X}}_{m} = {V}_{m}^{T} x = {v}_{m} , x$$

The frequency distribution of the differential testing signal in the sliced graph satisfies:

$$\tilde{X} = {V}^{T} x , x ∈ {R}^{N}$$

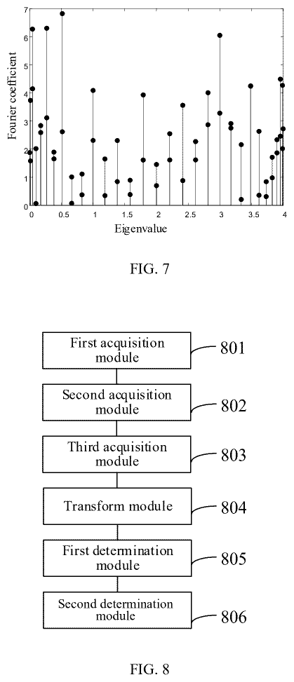

FIG. 6 is a schematic spectrum diagram of sliced graphs corresponding to broken wire positions according to an embodiment of the present application. FIG. 6(a), FIG. 6(b), FIG. 6(c), and FIG. 6(d) respectively correspond to four broken wire positions. FIG. 7 is a schematic spectrum diagram of a sliced graph corresponding to a position without any broken wire according to an embodiment of the present application. In FIG. 6 and FIG. 7, the abscissa is the eigenvalue, and the ordinate is the graph Fourier transform coefficient. The graph Fourier transform coefficient is equivalent to the amplitude of the graph signal at the corresponding frequency component, and reflects the strength of the graph signal at said frequency component.

As can be seen by comparing FIG. 6 and FIG. 7, the frequency of the graph signal in a sliced graph having a broken wire defect is concentrated in a low frequency range, and the amplitude of the low frequency is relatively large, whereas the frequency distribution of the graph signal in a sliced graph without any broken wire defect is relatively uniform.

S6, determining a low-frequency signal energy characteristics value of each sliced graph on the basis of the frequency spectrum of the graph signal in each sliced graph. The energy of the graph signal satisfies:

$$G E ( x ) = ‖ x ‖ = {x}^{T} x = {( V \tilde{X} )}^{T} ( V \tilde{X} ) = {\tilde{X}}^{T} X$$

The low-frequency cut-off frequency is set to 10 to calculate the low-frequency signal energy characteristics value of each sliced graph:

$$L G E ( x ) = {\sum }_{m = 1}^{T H L} {V}_{m}^{T} x$$

According to the above formula, the low-frequency signal energy characteristics values of the sliced graphs corresponding to the broken wire positions in layers 1 to 4 are finally calculated as 91866.3, 25088.8, 22123.3, and 3561.0, respectively, and the low-frequency signal energy characteristics value of the sliced graph corresponding to the position without any broken wire is 135.2. The difference between a low-frequency signal energy characteristics value of a sliced graph with a broken wire and a low-frequency signal energy characteristics value of a sliced graph without any broken wire is significant, and in addition, it can be seen that the low-frequency signal energy characteristics value has the tendency of decreasing as the broken wire depth increases.

Further, as can be seen with reference to FIG. 4, the signal fluctuation of a deeper-layer broken wire is very insignificant, and is prone to be ignored by conventional manual determination. However, in the graph structure-based cable magnetic flux leakage testing method provided by the embodiments of the present application, the low-frequency signal energy value of the sliced graph corresponding to the broken wire in layer 4 is much greater than the low-frequency signal energy value of the sliced graph corresponding to a position without any broken wire, thereby achieving effective testing and identification for a deeper-layer broken wire.

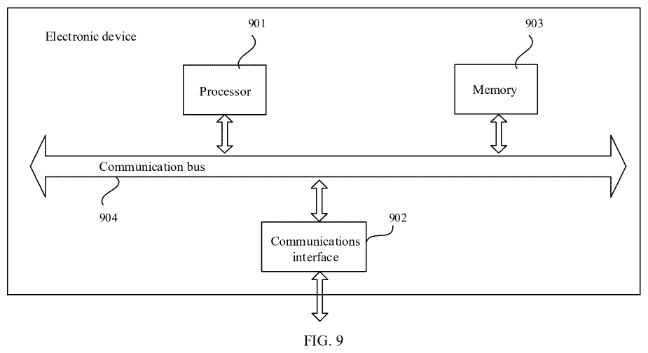

FIG. 8 is a schematic structural diagram of a leakage magnetic field graph testing apparatus for in-service cable damage according to an embodiment of the present application. As shown in FIG. 8, the apparatus at least includes:
a first acquisition module 801, configured to acquire multi-channel detection signals corresponding to respective testing units in a testing probe;
a second acquisition module 802, configured to slice the multi-channel detection signals acquired at different detection positions to acquire sliced detection data at a plurality of detection positions in an axial direction of a cable under test;
a third acquisition module 803, configured to map the sliced detection data to a pre-constructed graph structure to acquire sliced graphs, wherein the graph structure is established on the basis of spatial distribution of the testing units in the testing probe, the testing units serving as nodes, and adjacency relationships between the testing units in the testing probe serving as edges;
a transform module 804, configured to determine a frequency spectrum of a graph signal in each sliced graph by means of a graph Fourier transform;
a first determination module 805, configured to determine a low-frequency signal energy characteristics value of each sliced graph on the basis of the frequency spectrum of the graph signal in each sliced graph; and a second determination module 806, configured to determine, on the basis of the low-frequency signal energy characteristics value of each sliced graph, whether damage is present at a detection position corresponding to the sliced graph.

In some embodiments, the transform module 804 specifically includes:
an eigen decomposition unit, configured to perform eigen decomposition on a Laplacian matrix of the sliced graph, determine an eigenvalue matrix and a corresponding eigenvector matrix, use an eigenvalue as a frequency of the graph signal, and use an eigenvector as a graph Fourier transform basis;
a first determination unit, configured to determine a graph Fourier transform coefficient at each frequency component on the basis of node data in the sliced graph; and
a second determination unit, configured to determine the frequency spectrum of the graph signal in the sliced graph on the basis of the graph Fourier transform coefficient.

In some embodiments, the first determination module 805 includes:
a third determination unit, configured to determine energy of the graph signal on the basis of the frequency spectrum of the graph signal in the sliced graph; and
a fourth determination unit, configured to accumulate low-frequency signal energies in the graph signal that have frequencies less than a low-frequency cut-off frequency, and determine the low-frequency signal energy characteristics value of the sliced graph.

In some embodiments, the second determination module 806 includes:
a fifth determination unit, configured to compare the low-frequency signal energy characteristics value of each sliced graph with a standard characteristics value, and determine that damage is present at a detection position corresponding to a sliced graph of which the low-frequency signal energy characteristics value is greater than the standard characteristics value.

In some embodiments, the standard characteristics value is determined in the following manners:
determining the standard characteristics value on the basis of a predetermined low-frequency signal energy characteristics value of a sliced graph without any damage; or,
determining the standard characteristics value on the basis of a minimum value among the low-frequency signal energy characteristics values of the respective sliced graphs.

In some embodiments, the first acquisition module 801 includes:
a preprocessing unit, configured to preprocess detection signals output by magneto sensitive elements in the respective testing units to acquire the multi-channel detection signals corresponding to the respective testing units.

In some embodiments, each testing unit includes K magneto sensitive elements, K being a positive integer. The preprocessing unit is specifically configured to perform the following:
if the value of K is 1, performing denoising processing and drift removal processing on a testing signal of the one magneto sensitive element in the testing unit; or,
if the value of K is greater than 1, performing differential processing on detection signals of the K magneto sensitive elements in the testing unit; or,
if the value of K is greater than 1, performing differential processing on detection signals of the K magneto sensitive elements in the testing unit, and further performing denoising processing and drift removal processing on differential detection signals.

In some embodiments, the apparatus further includes:
a graph structure establishment unit, configured to establish a ring graph structure G=(V,E) on the basis of the spatial distribution of the testing units in the testing probe, wherein V={v₁, v₂, . . . , v_{M}} represents a node set of the graph structure, E={e₁, e₂, . . . , e_{M}} represents an edge set of the graph structure, and M represents the number of testing units in the testing probe; and the testing units in the testing probe are uniformly distributed in a circumferential direction of the cable under test;
a sixth determination unit, configured to determine an adjacency matrix and a degree matrix of the graph structure, and determine a Laplacian matrix on the basis of the adjacency matrix and the degree matrix.

It can be understood that for the detailed implementation of the functions of each aforementioned unit/module, the descriptions of the foregoing method embodiments may be referred to, and details are not described herein again.

It should be understood that the above apparatus is configured to perform the method in the above embodiments, and the implementation principles and technical effects of corresponding program modules in the apparatus are similar to those described in the above method. For the working process of the apparatus, reference may be made to the corresponding process in the above method, and details are not described herein again.

On the basis of the method in the above embodiments, an embodiment of the present application provides an industrial personal computer. Said device may include: at least one memory configured to store a program and at least one processor configured to execute the program stored by the memory. When the program stored by the memory is executed, the processor is configured to perform the method described in the above embodiments.

FIG. 9 is a schematic structural diagram of an industrial personal computer according to an embodiment of the present application. As shown in FIG. 9, the industrial personal computer may include: a processor 901, a communications interface 902, a memory 903, and a communication bus 904. The processor 901, the communications interface 902, and the memory 903 communicate with each other via the communication bus 904. The processor 901 can invoke software instructions in the memory 903 to perform the method described in the above embodiments.

In addition, logic instructions in the memory 903, when implemented in the form of a software functional unit and sold or used as an independent product, may be stored in a computer-readable storage medium. Based on such understanding, the essence of the technical solutions of the present application or the part that makes contributions to the related art, or part of the technical solutions may be embodied in the form of a software product. The computer software product is stored in a storage medium and includes several instructions used to enable a computer device (which may be a personal computer, a server, a network device, or the like) to perform all or some of the steps of the method described in the embodiments of the present application.

1. A leakage magnetic field graph testing method for in-service cable damage, characterized by comprising:
acquiring multi-channel detection signals corresponding to respective testing units in a testing probe;
slicing the multi-channel detection signals acquired at different detection positions to acquire sliced detection data at a plurality of detection positions in an axial direction of a cable under test;
mapping the sliced detection data to a pre-constructed graph structure to acquire sliced graphs, wherein the graph structure is established on the basis of spatial distribution of the testing units in the testing probe, the testing units serving as nodes, and adjacency relationships between the testing units in the testing probe serving as edges;
determining a frequency spectrum of a graph signal in each sliced graph by means of a graph Fourier transform;
determining a low-frequency signal energy characteristics value of each sliced graph on the basis of the frequency spectrum of the graph signal in each sliced graph; and
determining, on the basis of the low-frequency signal energy characteristics value of each sliced graph, whether damage is present at a detection position corresponding to the sliced graph.

2. The leakage magnetic field graph testing method for in-service cable damage according to claim 1, wherein the determining a frequency spectrum of a graph signal in each sliced graph by means of a graph Fourier transform comprises:
performing eigen decomposition on a Laplacian matrix of the sliced graph, determining an eigenvalue matrix and a corresponding eigenvector matrix, using an eigenvalue as a frequency of the graph signal, and using an eigenvector as a graph Fourier transform basis;
determining a graph Fourier transform coefficient at each frequency component on the basis of node data in the sliced graph; and
determining the frequency spectrum of the graph signal in the sliced graph on the basis of the graph Fourier transform coefficient.

3. The leakage magnetic field graph testing method for in-service cable damage according to claim 1, wherein the determining low-frequency signal energy characteristics value of each sliced graph on the basis of the frequency spectrum of the graph signal in each sliced graph comprises:
determining energy of the graph signal on the basis of the frequency spectrum of the graph signal in the sliced graph; and
accumulating low-frequency signal energies in the graph signal that have frequencies less than a low-frequency cut-off frequency, and determining the low-frequency signal energy characteristics value of the sliced graph.

4. The leakage magnetic field graph testing method for in-service cable damage according to claim 1, wherein the determining whether damage is present at a detection position corresponding to the sliced graph comprises:
comparing the low-frequency signal energy characteristics value of each sliced graph with a standard characteristics value, and determining that damage is present at a detection position corresponding to a sliced graph of which the low-frequency signal energy characteristics value is greater than the standard characteristics value.

5. The leakage magnetic field graph testing method for in-service cable damage according to claim 4, wherein the standard characteristics value is determined in the following manners:
determining the standard characteristics value on the basis of a predetermined low-frequency signal energy characteristics value of a sliced graph without any damage; or,
determining the standard characteristics value on the basis of a minimum value among the low-frequency signal energy characteristics values of the respective sliced graphs.

6. The leakage magnetic field graph testing method for in-service cable damage according to claim 1, wherein the acquiring multi-channel detection signals output by respective testing units in a testing probe comprises:
preprocessing testing signals output by magneto sensitive elements in the respective testing units to acquire the multi-channel detection signals corresponding to the respective testing units.

7. The leakage magnetic field graph testing method for in-service cable damage according to claim 6, wherein each of the testing units comprises K magneto sensitive elements, K being a positive integer, and the preprocessing detection signals output by magneto sensitive elements in the respective testing units comprises:
if the value of K is 1, performing denoising processing and drift removal processing on a testing signal of the one magneto sensitive element in the testing unit; or,
if the value of K is greater than 1, performing differential processing on detection signals of the K magneto sensitive elements in the testing unit; or,
if the value of K is greater than 1, performing differential processing on detection signals of the K magneto sensitive elements in the testing unit, and further performing denoising processing and drift removal processing on differential detection signals.

8. The leakage magnetic field graph testing method for in-service cable damage according to claim 1, further comprising:
configuring the testing units in the testing probe to be uniformly distributed in a circumferential direction of the cable under test, and establishing a ring graph structure G=(V,E) on the basis of the spatial distribution of the testing units in the testing probe, where V={v₁, v₂, . . . , v_{M}} represents a node set of the graph structure, E={e₁, e₂, . . . , e_{M}} represents an edge set of the graph structure, and M represents the number of the testing units in the testing probe; and
determining an adjacency matrix and a degree matrix of the graph structure, and determining a Laplacian matrix on the basis of the adjacency matrix and the degree matrix.

9. An industrial personal computer, characterized by comprising:
at least one memory, configured to store a computer program; and
at least one processor, configured to execute the program stored by the memory, wherein when the program stored by the memory is executed, the processor is configured to perform the method according to claim 1.

10. A computer-readable storage medium, having a computer program stored therein, characterized in that: when the computer program is run on a processor, the processor is caused to perform the method according to claim 1.
